(19) United States
(12) Patent Application Publication
(10) Pub. No.: US 2004/0115363 A1
(43) Pub. Date: Jun. 17, 2004

(54) Sealant and sound dampening composition

(76) Inventors: Umesh C. Desai, Wexford, PA (US); Anthony C. Palermo, Gibsonia, PA (US); Kaliappa G. Ragunathan, Gibsonia, PA (US)

Correspondence Address: PPG INDUSTRIES, INC., Intellectual Property Department, One PPG Place, Pittsburgh, PA, 15272, US

(21) Appl. No.: 10/319,298

(22) Filed: Dec. 13, 2002

(51) Int. Cl. B05D 3/06

(52) U.S. Cl. 427/508; 427/385.5; 427/558

(57) ABSTRACT

A composition for application to a sound transmitting article so as to dampen the sound transmitted through the article comprising: one or more thermally curable materials; one or more UV crosslinkable materials different from the thermally curable materials; and one or more photoiniators.

### FIELD OF THE INVENTION

The present invention relates to compositions having sealing and sound dampening properties; especially compositions having sealing and sound dampening properties that contain ultraviolet (“UV”) crosslinkable materials and thermally curable materials.

### BACKGROUND OF THE INVENTION

Sealants and sound dampeners are applied to a variety of automotive parts such as interior floor pans, firewalls, decklids, and between the inner and outer panels of doors. Sealants and sound dampeners are usually applied in the paint shop of an automobile body assembly line. The paint shop is the area of an automobile assembly line where paint is applied and cured.

When sealants and sound dampeners are applied to an automotive part in the paint shop, the part often contains fingerprints and/or overspray. Fingerprints and overspray are not desirable on the painted part so some type of cleaning process is usually performed in the paint shop to remove the fingerprints and/or overspray.

Before an automotive body is sent to the paint shop, it passes through a body shop. The body shop of an automobile assembly line is the area in front of the electrodeposition tanks where the body of the automobile is assembled. If a sealant and sound dampening composition could be applied in the body shop, any fingerprints and/or overspray that get on the body of the automobile during the application process could be removed by the body shop pretreatment wash cycle. During the body shop pretreatment wash cycle, the automobile body is exposed to various cleaning solutions before it goes to the paint shop. Application of a sealant and sound dampening composition in the body shop would allow a step in the paint shop to be eliminated—the fingerprint and overspray removal step.

Conventional sealants and sound dampening compositions do not exhibit the performance characteristics necessary for widespread commercial use in body shops. A sealant and sound dampening composition for body shop application must exhibit the following performance attributes. First, the composition must be capable of bonding to an oily substrate. Second, the composition must remain on the substrate when exposed to the body shop pretreatment wash cycle. And third, the composition must impart corrosion resistance properties to the substrate.

An example of a coating composition having vibration and harsh noise reduction or absorption properties is disclosed in International Application WO 99/16840.

There is a need for a sealant and sound dampening composition that can be applied in the body shop to an oily substrate and remain on the substrate when exposed to the body shop pretreatment wash cycle. The present invention provides such a composition.

### SUMMARY OF THE INVENTION

In one embodiment, the present invention is a composition for application to a sound transmitting article so as to dampen the sound transmitted through the article comprising:

a. one or more thermally curable materials;

b. one or more UV crosslinkable materials different from (a); and

c. one or more photoinitiators.

In another embodiment, the present invention is a method for applying a sound dampening composition to portions of a substrate comprising the following steps:

a. applying the sound dampening composition to a portion of the substrate comprising:

i) one or more thermally curable materials;

ii) one or more UV crosslinkable materials different from (i); and

iii) one or more photoinitiators.

b. crosslinking the sound dampening composition using a ultraviolet source; and

c. thermally curing the sound dampening composition.

### DESCRIPTION OF THE INVENTION

The present invention is a sealant and sound dampening composition comprising one or more thermally curable materials, one or more UV crosslinkable material, and a photoinitiator.

The present invention comprises one or more thermally curable materials. Suitable thermally curable materials include systems of the following: epoxy resins and appropriate curing agents; polymer polyols such as hydroxyl containing acrylic polymers and appropriate curing agents; polyester polyols and appropriate curing agents; and polyurethane polyols and appropriate curing agents. Also, thermally fusible materials such as PVC plastisol can be used.

Suitable epoxy resins are well known in the art. Suitable epoxy resins include polyepoxides in which the resin contains at least two epoxide groups per molecule. The polyepoxides may be saturated or unsaturated, cyclic or acyclic, aliphatic, alicyclic, aromatic, or heterocyclic. The polyepoxides can contain substituents such as halogens, hydroxyl groups, and ether groups.

Other suitable epoxy resins include glycidyl ethers, glycidyl esters, glycidyl amines, linear-aliphatic epoxides and alicyclic epoxides, and modified epoxy resins derived therefrom. For example, glycidyl ethers of polyhydric phenols, polyglycidyl ethers of polyhydric alcohols, and polyglycidyl esters of polycarboxylic acids can be used in the present invention.

Examples of glycidyl ethers of polyhydric phenols include bisphenol A and bisphenol F. The glycidyl ethers of polyhydric phenols can be obtained by reacting epichlorohydrin and bisphenols.

Polyglycidyl ethers of polyhydric alcohol can be derived from polyhydric alcohols like ethylene glycol, propylene glycol, butylene glycol, 1,6-hexylene glycol, neopentyl glycol, diethylene glycol, glycerol, trimethylol propane, and pentaerythritol. The polyglycidyl ethers can also be derived from polymeric polyols such as polypropylene glycol, polyurethane polyols, and polyesters polyols.

Polyglycidyl esters of polycarboxylic acid can be formed by reacting epichlorohydrin or another epoxy material with an aliphatic or aromatic polycarboxylic acid such as succinic acid, adipic acid, azelaic acid, sebacic acid, maleic acid, 2,6-naphthalene dicarboxylic acid, fumaric acid, phthalic acid, tetrahydrophthalic acid, hexahydrophthalic acid, or trimellitic acid. Polyglycidyl esters of polycarboxylic acids can also be formed from dimerized unsaturated fatty acids containing about 36 carbon atoms.

Suitable epoxy resins also include epoxy novolac resins. Epoxy novolac resins can be obtained by reacting an epihalohydrin with the condensation product of aldehyde and monohydric or polyhydric phenols.

The epoxy resins utilized in the present invention can have the following characteristics. Typically, the epoxy resins will have a number average molecular weight between 100 and 5,000 or 150 and 1,500. The weight average molecular weight of the epoxy resins will usually be between 100 and 8,000 or 150 and 5,000.

Suitable curing agents for epoxy resins include polyamines, anhydrides, imidazoles, polyureas, polyamides, dicyandiamide, and polyacids. The curing agents will be present in an amount sufficient to cure the epoxy resin.

The thermally curable materials can comprise a system of alkyd resins and an appropriate curing agent(s). Suitable alkyd resins include polyesters formed from polyhydroxyl alcohols, polycarboxylic acids, and fatty acids as is well known in the art. The polyhydroxyl alcohols can be glycerol, trimethylolethane, trimethylolpropane, pentaerythritol, sorbitol, mannitol, ethylene glycol, diethylene glycol and 2,3-butylene glycol. The polycarboxylic acids can be phthalic acid, maleic acid, fumaric acid, isophthalic acid, succinic acid, adipic acid, azelaic acid, sebacic acid as well as the anhydrides of such acids. Examples of fatty acids are tall oil, castor oil, soybean oil, and linseed oil.

Suitable curing agents for alkyd resins include aminoplasts and polyisocyanates. The aminoplast can be obtained from the reaction of formaldehyde with an amine or an amide as is well known in the art. Examples of amines or amides include melamine, urea or benzoguanamine.

Suitable polyisocyanates include toluene diisocyanate, 4,4′-methylene-bis-(cyclohexyl isocyanate), isophorone diisocyanate, and isocyanate-prepolymers. The polyisocyanate can be blocked or unblocked.

The curing agents will be present in an amount sufficient to cure the alkyd resin.

The thermally curable materials can comprise a system of polyester polyols and an appropriate curing agent(s). Suitable polyester polyols can be prepared by the polyesterification of an organic polycarboxylic acid or anhydride thereof with organic polyols and/or an epoxide as is well known in the art.

Suitable organic polycarboxylic acids include carboxylic acids or anhydrides. The following acids can be used: phthalic acid, isophthalic acid, terephthalic acid, tetrahydrophthalic acid, hexahydrophthalic acid, adipic acid, azelaic acid, sebacic acid, maleic acid, glutaric acid, chlorendic acid, tetrachlorophthalic acid, and other dicarboxylic acids of varying types. Minor amounts of monobasic acids such as benzoic acid, stearic acid, acetic acid, hydroxystearic acid and oleic acid can be included. Higher polycarboxylic acids such as trimellitic acid and tricarballylic acid can also be used.

It is understood that anhydrides of the abovementioned acids can be used in place of the acids. Lower alkyl esters of the acids such as dimethyl glutarate and dimethyl terephthalate can also be used in place of the acid.

Suitable organic polyols include the following diols: alkylene glycols such as ethylene glycol, neopentyl glycol, other glycols such as hydrogenated bisphenol A, cyclohexanediol, cyclohexanedimethanol, caprolactonediol, hydroxy-alkylated bisphenols, polyether glycols. Suitable organic polyols also include polyols of higher functionality like trimethylolpropane, trimethylolethane, and pentaerythritol as well as high molecular weight polyols. High molecular weight polyols can be produced by oxyalkylating low molecular weight polyols.

Suitable curing agents for polyester polyols are described above in the discussion on alkyd resins. The curing agents will be present in an amount sufficient to cure the polyester polyols.

The thermally curable materials can also comprise a system of hydroxy-containing acrylic polymers and an appropriate curing agent(s). Suitable hydroxy-containing acrylic polymers include interpolymers of hydroxy-containing vinyl monomers such as hydroxyalkyl acrylate and methacrylate and other ethylenically unsaturated copolymerizable materials such as alkyl acrylates and methacrylates. The hydroxyalkyl acrylates and methacrylates can be acrylic acid and methacrylic acid esters of ethylene glycol and propylene glycol, hydroxy-containing esters and/or amides of unsaturated acids such as maleic acid, fumaric acid, and itaconic acid. The alkyl acrylates and methacrylates can be lauryl methacrylate, 2-ethylhexyl methacrylate, and n-butyl acrylate.

Suitable hydroxy-containing acrylic polymers can be formed from the copolymerization of ethylenically unsaturated monomers such as monoolefinic and diolefinic hydrocarbons, halogenated monoolefinic and diolefinic hydrocarbons, unsaturated esters of organic and inorganic acids, amides and esters of unsaturated acids, nitriles, and unsaturated acids. Unsaturated acids can also be copolymerized with hydroxyalkyl acrylates and methacrylates. Examples of the ethylenically unsaturated monomers include styrene, 1,3-butadiene, acrylamide, acrylonitrile, alpha-methyl styrene, alpha-methyl chlorostyrene, vinyl butyrate, vinyl acetate, allyl chloride, divinyl benzene, diallyl itaconate, triallyl cyanurate, and mixtures thereof. The ethylenically unsaturated materials can be used in admixture with the above-mentioned acrylates and methacrylates.

Suitable curing agents for hydroxy-containing acrylic polymers are described above in the discussion on alkyd resins. The curing agents will be present in an amount sufficient to cure the hydroxy-containing acrylic polymers.

The thermally curable materials can further comprise a system of polyurethane polyols and an appropriate curing agent(s). Suitable polyurethane polyols can be prepared by reacting certain polyols with a minor amount of polyisocyanate (OH/NCO equivalent ratio greater than 1:1) as is well known in the art. Suitable polyols include diols and triols such as aliphatic polyols, for example, alkylene polyols containing from 2 to 18 carbon atoms. Other suitable diols include ethylene glycol, 1,4-butanediol, 1,6-hexanediol, cycloaliphatic polyols such as 1,2-hexanediol, and cyclohexanedimethanol. Other suitable triols include trimethylolpropane and trimethyloletbane. Polyols containing ether linkages such as diethylene glycol and triethylene glycol can also be used. Also, acid-containing polyols such as dimethylolpropionic acid can be used.

The polyisocyanate can be an aliphatic or an aromatic isocyanate or a mixture of the two.

Suitable curing agents for polyurethane polyols are described above in the discussion on alkyd resins. The curing agents will be present in an amount sufficient to cure the polyurethane polyols.

The thermally curable materials are present in an amount ranging from 5 to 70 or from 10 to 40 or from 12 to 25, weight percent based on the total weight of the composition.

The present invention also comprises one or more ultraviolet light (UV) crosslinkable materials. The UV crosslinkable materials crosslink upon exposure to UV light. Suitable UV crosslinkable materials can be classified as either free radically polymerizable oligomers and monomers or cationically polymerizable oligomers and monomers. Free radically polymerizable oligomers and monomers and cationically polymerizable oligomers and monomers are well known in the art.

Suitable free radically polymerizable monomers and oligomers include oligomers containing polymerizable ethylenic unsaturation. Examples of suitable oligomers containing polymerizable ethylenic unsaturation are polyurethane acrylates, polyester acrylates, polyether acrylates, polyacrylates derived from polyepoxides, acrylate functional acrylic polymers, unsaturated polyesters, and polyvinyl ethers. The polyurethane acrylates, polyester acrylates, polyacrylates derived from polyepoxides, and acrylate functional acrylic polymers can be prepared from polyurethane polyols, polyester polyols, polyether polyols, polybutadiene polyols, acrylic polyols, and epoxide resins by reacting all or portions of the hydroxyl groups or epoxy groups with acrylic or methacrylic acid. Also, polyols like pentaerythritol and trimethylol propane, propylene glycol, and ethylene glycol can be used.

Acryalate functional compounds can also be obtained by transesterifiying polyols with lower alcohol esters of (meth)acrylic acid.

Polyurethane (meth)acrylates can be prepared by reacting isocyanate functional prepolymers with hydroxy functional (meth)acrylates.

Urethane (meth)acrylate functional oligomers can be prepared by reacting polyfunctional isocyanates with hydroxy-functional (meth)acrylates. Urethane acryalates can also be prepared by reacting polyols with acrylate functional isocyanates like methacryloyloxyethyl isocyanate.

Acrylic polyols can be derived from the following monomers: methyl acrylate, methyl methacrylate, ethyl acrylate, ethyl methacrylate, n-butyl acrylate, n-butyl methacrylate, isobutyl acrylate, isobutyl methacrylate, 2-ethylhexyl acrylate, 2-ethylhexyl methacrylate, 2 hydroxyethyl acrylate, 4 hydroxybutyl acrylate, and the like.

Suitable free radically polymerizable oligomers include cycloaliphatic or aromatic diacrylates. Suitable cycloaliphatic or aromatic diacrylates include diacrylates of cycloaliphatic or aromatic diols such as 1,4-dihydroxymethylcyclohexane, 2,2-bis(4-hydroxycyclohexyl)propane, bis(4-hydroxycyclohexyl)methane, hydroquinone, 4,4′-dihydroxybiphenyl, bisphenol A, bisphenol F, bisphenol S, ethoxylated or propoxylated bisphenol A, ethoxylated or propoxylated bisphenol F or ethoxylated or propoxylated bisphenol S. Other suitable cycloaliphatic or aromatic diacrylates are disclosed in U.S. Pat. No. 3,968,016 and U.S. Pat. No. 4,020,193 which are hereby incorporated by reference. Metal (meth)acrylates such as zinc diacrylate, lanthanum triacrylate and zirconium tetraacrylate can be used.

Suitable cationically polymerizable oligomers and monomers include epoxy resins such as those mentioned above and vinyl ethers. When the epoxy resins are used as the UV crosslinkable materials, the thermally curable materials should be comprised of a suitable thermally curable material other than epoxy resins.

The UV crosslinkable materials are present in an amount ranging from 5 to 90 or from 7 to 50 or from 10 to 30, weight percent based on the total weight of the composition.

The present invention can also comprise photoinitiators. Depending on the type of UV crosslinkable materials used in the composition, either free radical photoinitiators or cationic photoinitiators can be included. Both types of photoinitiators are well known in the art, and one of ordinary skill in the art possesses the knowledge to select suitable photoinitiators depending on the light source.

Examples of suitable free radical photoinitiators include benzoin and benzoin derivatives. Examples of benzoin derivatives are benzoin ethers such as isobutyl benzoin ether and benzyl ketals such as benzyl dimethyl ketal, 2-hydroxy-2-methyl-1-phenylpropan-1-one and 4-(2-hydroxyethoxy) phenyl-2-hydroxy-2-propyl ketone. Acyl phosphines such as 2,4,6-trimethylbenzoyl diphenylphosphine oxide and bis (2,4,6-trimethylbenzoyl) phenylphosphine oxide can also be used as free radical photinitiators. Further, aryl ketones such as 1-hydroxycyclohexyl phenyl ketone, 2-benzyl-2-dimethylamino-1-(4-morpholinophenyl)-butan-1-one, 2,2-dimethoxy-2-phenylaceto-phenone, and 2-methyl-1-(4-(methylthiophenyl)-2-(4-morpholinyl))-1-propanone can be used as free radical photoinitiators.

The following compounds can be used alone as the free radical photoinitiator or in combination with amine synergist: Michler's ketone (4,4′-bisdimethylamino benzophenone), Michler's ethyl ketone (4,4′-bisdiethylamino benzophenone ethyl ketone), benzophenone, thioxanthone, anthroquinone, d, 1-camphorquinone, ethyl d, 1-camphorquinone, ketocoumarin, anthracene, etc. Metallocene photoinitiators like dialkyl titanocenes can also be used.

An example of a suitable free radical photoinitiator is the combination of the following products which are commercially available from Ciba Specialty Chemicals: Irgacure 784, Irgacure 819, and Irgacure 651.

Suitable cationic photoiniators include diaryliodonium salts; copper synergists such as diphenyl iodonium hexafluorophosphate, dibenzyl iodonium hexaflouroarsinate, and copper acetate; triarylsulfonium salts such as triphenyl sulphonium hexafluorophosphate; and triphenyl sulphonium tertafluoroborate. Dialkylphenacyl-sulfonium salts, ferrocenium salts such as cyclopentadienyl iron(II) hexafluorophosphate, alpha-sulfonyloxy ketone, and silyl benzyl ethers can also be used.

The photoiniators used in the present invention can have an absorption range from 200-800 nm. The photoinitiators are present in an amount ranging from 0.01 to 10 weight percent based on the total weight of the composition.

The coating composition can include additives which are well known in the art like polymeric or silicone coating surface improvers, flow improvers, dyes, thermal initiators, pigments, fillers, corrosion inhibitors, moisture scavengers, flatting agents (e.g. wax-coated or non-wax-coated silica or other inorganic materials), reactive diluents, shrink control agents, and a thixotrope.

Suitable fillers may be spherical or platy (i.e., have a high aspect ratio). The fillers can be talc, mica, carbonates, and graphite. The filler can be present in an amount up to 70 or from 15 to 70 or from 30 to 60, weight percent based on the total weight of the composition.

The present invention can contain peroxides or hydroperoxides. These materials thermally cure any unsaturated components that remain after the UV curing step.

The compositions according to the invention can be prepared by methods which are well known in the art. For example, the compositions can be prepared by pre-mixing individual components and subsequently mixing those premixtures or by mixing all of the components by means of customary apparatuses such as impeller-type mixers.

The coating composition of the present invention can be applied via conventional coating methods which are well known in the automotive industry. For example, the coating compositions can be applied by painting, spraying, or spreading. A high volume, high pressure, airless sprayer can be used. Manual or robotic application can be used.

After the coating composition is applied, it can be crosslinked by irradiation with ultraviolet rays as is known to those skilled in the art. Suitable sources of UV irradiation include mercury lamps, iron halide lamps, and gallium halide lamps. Typically, the UV source will emit wavelengths between 200-650 nm.

The number of UV sources and the speed of the line can be modified to obtain an energy absorption level that is sufficient to gel the coating composition. Typically, the energy input will be between 0.7 to 3.0 Joules/cm².

After the composition is exposed to a UV source and crosslinks, the coating composition is thermally cured. Thermal curing involves heating the composition to temperatures ranging from about 250 to about 400 or about 325 to about 375, degrees Fahrenheit.

Thermal curing can be done in an electrocoat oven or in a paint oven on an automotive assembly line.

The composition of the present invention can be applied to various substrates. For example, the substrate can be an automotive part like a firewall, door, floorpan, or decklid. The composition can be applied directly to the substrate or over a cured or uncured coating layer.

The dry film thickness of the cured composition ranges from about 20 to about 200 or about 40 to about 120 or about 50 to 100, mils.

### EXAMPLES

The present invention is illustrated by the non-limiting examples shown below. Table I contains formulation data for compositions prepared according to the present invention. For evaluation purposes, the various exemplary coating compositions were mixed, drawn down on a substrate, crosslinked via exposure to a UV light source, and subjected to various tests. The total energy input from the UV light source was between 1-2 Joules/cm².

Table 2 shows values of the Shore 00 Hardness and the thickness of the UV cured layers for various exemplary coatings which were cured via UV exposure (1 pass of a D lamp at 12 ft/min) followed by 30 minutes at room temperature. The Shore 00 Hardness Test is described in ASTM D 2240-00. The thickness of the UV cured layer was determined using calipers.

Table 3 shows the results of the “Wash Off” Test. To perform the Wash Off Test, a 0.1″×3″×10″ layer of exemplary coating composition was drawn down on a 4″×12″ cold rolled steel panel. The coating composition was then UV cured as described above. The coated panel was sprayed with 60° C. water at 1500 psi at the rate of 10 ft/min. The spraying was done across the coating and then along the coating. During the spraying, the water nozzle was 1-1.5 ft away from the panel. After spraying, the coating composition was baked and the degree of curing was examined.

Table 4 illustrates the sound deadening properties of coating compositions according to the present invention. The sound deadening was measured using the Oberst Sound Dampening Test which is described in ASTM E756-98. To perform the Oberst Sound Dampening Test, coating compositions were applied over a 0.5″×8.9″×0.032″ cold rolled steel substrate. The coating was then UV cured at 1.5-2 Joules/min followed by baking the coated substrate at 163° C. for 30 minutes. The dry film thickness of the applied coating layer was 0.08″; 0.9″ of substrate was left bare at one end so it could be attached to the Oberst fixture. The loss factor of the coated substrate was then measured at various temperatures and frequencies.

Table 5 shows the results of the VW Corrosion Test. To perform the VW Corrosion Test, compositions were drawn down in certain dimensions (2″×3″×0.130″) on various 4″×6″×0.032″ substrates. The coating composition of Example 2 was UV cured as described above and then baked at 163° C. for 30 minutes. B8029 Body Shop Audioguard (the control) which is commercially available from PPG Industries, Inc. was cured by baking at 171° C. for 25 minutes followed by further baking at 130° C. for 22 minutes. The cured coatings were crosshatched (an “X” was drawn on the substrate) with a razor blade down to the metal substrate and tested. During the VW Corrosion Test, the cured coating compositions were exposed to 90 repetitions or cycles of the following: 4 hours of salt spray (5% NaCl solution) at 100° F.; then 4 hours at room temperature (18-28° C.) and 40-60% relative humidity; followed by 16 hours at 40° C. and 100% relative humidity.

TABLE 1
Compositional Information

| Component | Example 1 | Example 2 | Example 3 | Example 4 | Example 5 | Example 6 | Example 7 |
|---|---|---|---|---|---|---|---|
| EPON 828¹ | 12.0 | 5.7 | 11.9 | | | | |
| EPALLOY | | 4.3 | | | | | |
| 5000² | | | | | | | |
| ERISYS GE-30³ | | 2.8 | | | | | |
| DER 736⁴ | 6.7 | 7.1 | 6.6 | | | | |
| DICY⁵ | 2.7 | 2.8 | 2.6 | | | | |
| ANCAMINE | | 1.4 | 11.9 | | | | |
| 2441⁶ | | | | | | | |
| Polyester | 3.3 | | 2.0 | | | | |
| polyurea⁷ | | | | | | | |
| TRILENE 65⁸ | 2.0 | 2.1 | 5.9 | | | | |
| Polyester | 14.7 | 14.2 | 6.6 | | | | |
| polyurea⁹ | | | | | | | |
| LAROMER | 6.7 | 5.7 | | | | | |
| 8981¹⁰ | | | | | | | |
| SARTOMER | | 5.7 | 4.0 | | | | |
| SR 355¹¹ | | | | | | | |
| Polyacrylate¹² | 4.0 | | 0.4 | 10 | 10 | 10 | 10 |
| IRGACURE | 0.4 | 0.14 | 0.07 | | | 0.6 | 0.6 |
| 651¹³ | | | | | | | |
| IRGACURE | 0.07 | | 0.07 | | | 0.1 | 0.1 |
| 819¹⁴ | | | | | | | |
| IRGACURE | 0.03 | 0.04 | 0.2 | | | 0.1 | 0.04 |
| 784¹⁵ | | | | | | | |
| Di-t-bu- | 0.2 | 0.4 | 10.0 | 0.4 | 0.4 | 0.4 | 0.4 |
| peroxide | | | | | | | |
| Mica | 8.9 | 6.9 | 32.9 | 6 | 6 | | |
| Dolocron¹⁶ | 33.4 | 35.6 | 0.7 | 10 | 10 | 10 | 10 |
| MgO | 0.7 | 0.7 | 0.4 | | | | |
| K-SPERSE | 0.4 | 0.4 | 0.4 | | | | |
| 6501¹⁷ | | | | | | | |
| INHIBICIL¹⁸ | 0.4 | 0.4 | 2.3 | | | | |
| CABOSIL TS- | 2.3 | 2.5 | 1.0 | | | | |
| 720¹⁹ | | | | | | | |
| BENTONE 27²⁰ | 1.0 | 1.1 | | | | | |
| FORMALON | | | | 10 | 10 | 10 | 10 |
| F-40²¹ | | | | | | | |
| FORMALON | | | | 5 | 5 | 5 | 5 |
| F-24²² | | | | | | | |
| VC-265²³ | | | | 15 | 15 | 15 | 15 |
| SANTICIZER | | | | 32 | 25 | 32 | 25 |
| 278²⁴ | | | | | | | |
| SLS-257²⁵ | | | | 4 | 4 | 4 | 4 |
| LAROMER | | | | 5 | | 5 | |
| 9004²⁶ | | | | | | | |
| EBECRYL830²⁷ | | | | 5 | | 5 | |
| CaO | | | | 1 | 1 | 13.3 | 13.3 |
| Barytes | | | | | 10 | | 10 |
| ULTRAFLEX²⁸ | | | | 15 | 15 | 15 | 15 |
| CABOSIL M- | | | | 0.5 | 0.5 | 0.5 | 0.5 |
| 5²⁹ | | | | | | | |

¹Diglycidyl ether of bisphenol A which is commercially available from Resolution Performance Products LLC
²Epoxidized hydrogenated bisphenol A which is commercially available from CVC Specialty Chemicals, Inc.
³Trimethylol propane triglycidyl ether which is commercially available from CVC Specialty Chemicals, Inc.
⁴Diglycidyl ether of polypropylene glycol which is commercially available from Dow Chemicals.
⁵Dicyandiamide.
⁶Powdered amine accelerator which is commercially available from Air Products.
⁷Polyester polyurea made from a reaction product of dimethylamine and isocyanate prepolymer made from 2 moles of IPDI and 1 mole of diethylene glycol adipate having a Mₙ = 1,000-1,200.
⁸Hydrocarbon oligomer which is commercially available from Union Carbide.
⁹Polyester polyurea made from a reaction product of dimethylamine and isocyanate prepolymer of 2 moles of IPDI and 1 mole of propylene glycol adipate having a Mₙ = 1,100-1,300.
¹⁰Polyester acrylate which is commercially available from BASF.
¹¹Di-trimethylol propane tetraacrylate which is commercially available from the Sartomer Company.
¹²Pentaerythritol tri and tetra acrylates.
¹³Photoinitiator which is commercially available from Ciba Specialty Chemicals.
¹⁴Photoiniator which is commercially available from Ciba Specialty Chemicals.
¹⁵Photoinitiator which is commercially available from Ciba Specialty Chemicals.
¹⁶Dolomite which is commercially available from Specialty Mineral.
¹⁷Zinc salt of nonyl sulfonic acid on silica which is commercially available from King Industries.
¹⁸Precipitated silica which is commercially available from PPG Industries, Inc.
¹⁹Fumed silica which is commercially available from Cabot.
²⁰Montmorillonite clay thixotrope which is commercially available from Elements Specialties.
²¹PVC/PVAc which is commercially available from Formosa Plastics Corp.
²²PVC which is commercially available from Formosa Plastics Corp.
²³PVC/PVAc which is commercially available from Borden Chemical.
²⁴High molecular weight benzyl phthalate which is commercially available from Ferro Corporation.
²⁵Odorless mineral spirit which is commercially available from Exxon.
²⁶Polyester acrylate which is commercially available from BASF.
²⁷Polyester hexa acrylate which is commercially available from UCB Chemicals.
²⁸Stearic acid coated CaCO3 which is commercially available from Pfizer.
²⁹Amorphous silica which is commercially available from Cabot.

TABLE 2
Shore Hardness Results

| | Example 1 | Example 4 | Example 5 | Example 6 | Example 7 |
|---|---|---|---|---|---|
| Shore 00 | 84-86 | Not gelled | Not gelled | 92-93 | 68-70 |
| Hardness | | | | | |
| Thickness of | 45-47 | 0 | 0 | 40-45 | 28-30 |
| UV cured | | | | | |
| layer [mils] | | | | | |

TABLE 3
Wash Off Test Results for Example 3

| Details of Specimen Tested | Observation |
|---|---|
| UV cured coating composition applied | During wash off spray, no draw- |
| on cold rolled steel | down movement was observed |
| 30 minutes at 163° C. after wash off | No blistering and good adhesion |
| 30 minutes at 190° C. after wash off | No blistering and good adhesion |

TABLE 4
Oberst Test Sound Deadening Test Results (Loss Factor)

| Cure Conditions: Bake at | | B8029 Body | | | | |
|---|---|---|---|---|---|---|
| 163° C. for 30 mins | | Shop | | | | |
| Temperature of substrate = 25° C. | Example 1 | Audioguard* | Example 4 | Example 5 | Example 6 | Example 7 |
| Frequency = 200 Hz | 0.105 | 0.117 | 0.032 | 0.061 | 0.054 | 0.064 |
| Frequency = 400 Hz | 0.119 | 0.127 | 0.042 | 0.080 | 0.062 | 0.084 |
| Frequency = 600 Hz | 0.134 | 0.137 | 0.052 | 0.098 | 0.069 | 0.103 |
| Frequency = 800 Hz | 0.149 | 0.147 | 0.061 | 0.117 | 0.077 | 0.123 |

*The control This product is commercially available from PPG Industries, Inc.

TABLE 5
VW Corrosion Test Results

| | | B8029 Body |
|---|---|---|
| Substrate | Example 2 | Shop Audioguard* |
| Hot dipped galvanized¹ | Slight blisters at | Adhesive failure, |
| | crosshatch; no adhesion | slight corrosion |
| | loss; no corrosion | |
| Electrogalvanized² | Slight blisters at | Adhesive failure, |
| | crosshatch, no adhesion | slight corrosion |
| | loss; no corrosion | |
| Bonazinc 3000³ over | Slight blisters at | Cohesive failure, |
| Electrogalvanized | crosshatch, no adhesion | no corrosion |
| | loss; no corrosion | |

¹HDG G70 70U, APR31893 which is commercially available from ACT Labs
²E60 EZG 60G, APR28112 which is commercially available from ACT Labs
³commercially available from PPG Industries, Inc.
*The control. This product is commercially available from PPG Industries, Inc.

### CONCLUSION

The test results show that dual cure sound dampening compositions can produce wash off resistant gelled surfaces after UV exposure and provide corrosion resistance after total cure.

We claim:

1. A coating composition for application to a sound transmitting article so as to dampen the sound transmitted through the article comprising:
a. one or more thermally curable materials;
b. one or more UV crosslinkable materials different from (a); and
c. one or more photoinitiators.

2. The coating composition according to claim 1 wherein said photoinitiators comprise free radical initiators.

3. The coating composition according to claim 1 wherein said one or more thermally curable materials comprise polyepoxides.

4. The coating composition according to claim 3 wherein said polyepoxides comprise at least two epoxide groups per molecule.

5. The coating composition according to claim 3 wherein said polyepoxides comprise epoxy polyethers.

6. The coating composition according to claim 1 wherein said one or more thermally curable materials are present in an amount ranging from 10 to 40 weight percent based on the total weight of the composition.

7. The coating composition according to claim 1 wherein said UV crosslinkable materials comprise an oligomer containing polymerizable ethylenic unsaturation.

8. The coating composition according to claim 7 wherein the oligomer is a polyurethane acrylate, polyester acrylate, acrylates derived from epoxy resin, polyether acrylate, an unsaturated polyester, or a polyvinyl ether.

9. The coating composition according to claim 1 wherein said UV crosslinkable materials are present in an amount ranging from 1 to 99 weight percent based on the total weight of the composition.

10. The coating composition according to claim 1 wherein said photoinitiators have an absorption range from 200-800 nm.

11. The coating composition according to claim 1 wherein said photoinitiators are present in an amount ranging from 0.01 to 10 weight percent based on the total weight of the composition.

12 A coating composition for application to a sound transmitting article so as to dampen the sound transmitted through the article comprising:
a. from 5 to 70 weight percent of thermally curable materials based on the total weight of the composition;
b. from 5 to 90 weight percent of UV crosslinkable materials which are different from (a) based on the total weight of the composition; and
c. from 0.01 to 10 weight percent of one or more photoinitiators based on the total weight of the composition.

13. A method for applying a sound dampening composition to portions of a substrate comprising the following steps:
a. applying the sound dampening composition to a portion of the substrate comprising:
i. one or more thermally curable materials;
ii. one or more UV crosslinkable materials different from (i); and
iii. one or more photoinitiators.
b. crosslinking the sound dampening composition using a ultraviolet source; and
c. thermally curing the sound dampening composition.

14. The method according to claim 13 wherein the substrate is an automotive part.

15. The method according to claim 14 wherein the automotive part is a firewall, door, floor pan, or decklid.

16. The method according to claim 13 wherein said crosslinking occurs in the body shop of an automotive assembly line.

17. The method according to claim 13 wherein said thermally curing the composition occurs in an electrocoat oven and/or paint shop of an automotive assembly line.

18. The method according to claim 13 wherein said applying the sound dampening composition is accomplished via spraying.

19. A sound dampened article comprising a layer of sound dampening material applied to a sound transmitting article wherein the sound dampening material is a cured composition according to claim 1.

20. The composition according to claim 1 wherein the composition is used as a sealant for sealing a welded joint or a seam between automotive components.
